(19) United States
(12) Patent Application Publication
(10) Pub. No.: US 2026/0151886 A1
(43) Pub. Date: Jun. 4, 2026

(54) Hand-Held Power Tool

(71) Applicant: Robert Bosch GmbH, Stuttgart (DE)

(72) Inventors: Choon Gim Ong, Georgetown (MY); Tai Keong Yeow, Penang (MY); Wei Hung Tai, Permatang Pauh (MY)

(21) Appl. No.: 19/403,399

(22) Filed: Nov. 28, 2025

(30) Foreign Application Priority Data
Dec. 2, 2024 (DE) 10 2024 211 499.5

(51) Int. Cl. B25F 3/00; B25F 5/02

(52) U.S. Cl. CPC B25F 3/00; B25F 5/02

(57) ABSTRACT

A hand-held power tool includes a housing with a power unit, a percussion mechanism that can be driven by the power unit, and a tool holder for receiving an insertion tool. The tool holder can be driven by the percussion mechanism, at least partially. The hand-held power tool includes a spacing component configured to space the insertion tool away from the housing.

This application claims priority under 35 U.S.C. § 119 to patent application no. DE 10 2024 211 499.5, filed on Dec. 2, 2024 in Germany, the disclosure of which is incorporated herein by reference in its entirety.

The present disclosure relates to a hand-held power tool.

### BACKGROUND

A hand-held power tool with a drive unit, a housing, a percussion mechanism and

a tool holder is already known from the prior art.

### SUMMARY

The present disclosure concerns a hand-held power tool comprising a housing, a power unit, a percussion mechanism that can be driven by the power unit, and a tool holder for receiving an insertion tool, wherein the tool holder can be driven by the percussion mechanism, at least partially. It is proposed that the hand-held power tool comprise a spacing component configured to space the insertion tool away from the housing.

The disclosure provides for a hand-held power tool, in which robustness of the tool holder is increased. The tool holder on hand-held power tools is a common location of failures, particularly fractures, under high stresses. Depending on the insertion tool used, the insertion tool may slide back and forth during operation of the tool holder. This causes, firstly, non-optimal torque transmission on the part of the percussion mechanism, and secondly, uneven loading of the tool holder. This can then result in stress peaks that lead to defective or broken tool holders over the long term. The present disclosure solves this problem.

The hand-held power tool can be configured as an electrically operated hand-held power tool. The electrically operated hand-held power tool can be configured as a plug-in or a cordless hand-held power tool. For example, the hand-held power tool can be designed as a screwdriver, a drill screwdriver, a rotary impact screwdriver, a hammer, a drill hammer or an impact drill screwdriver.

The housing of the hand-held power tool is configured to at least partly accommodate the drive unit, the percussion mechanism and the tool holder. The housing can be configured as a shell housing with two half shells.

The hand-held power tool comprises the drive unit. The drive unit comprises a drive motor and a transmission. The drive motor can be an electrically commutated motor. In particular, the drive motor can be designed as at least one electric motor. The transmission can be configured as at least one planetary gear, wherein it can, for example, be shiftable. The drive motor is configured such that it can be actuated via a manual switch. When the manual switch is actuated by a user, the drive motor is switched on and the hand-held power tool is put into operation. If the manual switch is not further actuated by the user, the drive motor is switched off. The drive motor can preferably be electronically controlled and/or regulated in such a way that a reversing mode and a specification for a desired rotational speed can be implemented. In reversing mode, the drive motor can be switched between a clockwise direction of rotation and a counterclockwise direction of rotation. To switch the drive motor in reversing mode, the hand-held power tool can comprise a rotation direction switching element, in particular a rotation direction changeover switch.

The hand-held power tool comprises a percussion mechanism. The percussion mechanism generates high torque peaks during operation to loosen tight connecting mechanisms or to fasten connecting mechanisms or to drill holes. The percussion mechanism can be connected to the drive motor by way of the transmission. The percussion mechanism can, for example, be designed as a rotational percussion mechanism, a detent percussion mechanism, a rotary percussion mechanism, a V-groove percussion mechanism or a hammer percussion mechanism. The transmission and/or the percussion mechanism can have an intermediate shaft. For example, the intermediate shaft can accommodate planetary gears of the transmission. Furthermore, the intermediate shaft can at least partially actuate the percussion mechanism. The percussion mechanism may comprise a percussion mechanism housing and/or a percussion mechanism cover. Furthermore, the percussion mechanism may comprise at least one striker or hammer and at least one percussion mechanism spring. The striker and the percussion mechanism spring can be located substantially within the percussion mechanism housing. The striker comprises at least one striking cam. There may be two or three striking cams, for example. The percussion mechanism spring can, for instance, be configured as a spiral spring, a barrel-shaped spring, a conical spring, a chimney spring or a profiled spring.

The hand-held power tool comprises the tool holder. The tool holder can be configured as an internal tool holder, for example a bit holder, and/or as an external tool holder, for example a socket holder. The tool holder can accommodate insertion tools, such as screwdriver bits, socket wrenches or sockets, so that a user can produce screw connections between a fastening element and a fastening holder. The percussion mechanism is configured to drive an output shaft. The output shaft is configured to drive the tool holder. The tool holder comprises at least one anvil cam on an end in the direction of the percussion mechanism and/or the power unit. The striker of the percussion mechanism is configured to rotate the anvil cam in the circumferential direction by way of the striking cam, thereby driving the tool holder. For example, the tool holder may comprise two or three anvil cams.

The hand-held power tool further includes a power supply, wherein the power supply is provided for cordless operation by way of rechargeable batteries, in particular hand-held power tool rechargeable battery packs, and/or for plug-in operation. In a preferred embodiment, the power supply is configured for cordless operation. In the context of the present disclosure, a “hand-held power tool rechargeable battery pack” is intended to be understood as a combination of at least one battery cell and a rechargeable battery pack housing. The hand-held power tool rechargeable battery pack is advantageously configured for supplying power to commonly available cordless hand-held power tools. The at least one battery cell can, for instance, be configured as a Li-ion battery cell having a nominal voltage of 3.6 V. The hand-held power tool rechargeable battery pack can include up to ten battery cells, for example, although a different number of battery cells is conceivable too. Both an embodiment as a cordless hand-held power tool and operation as a plug-in hand-held power tool are sufficiently well-known to those skilled in the art, so the specifics of the power supply will not be discussed here.

The hand-held power tool can have a control unit at least for controlling the drive unit. The control unit can be located in the housing, for example in a handle of the hand-held power tool or in a region of a power supply interface.

The spacing component is configured to space the insertion tool away from the housing. The spacing component thereby spaces the insertion tool such that the insertion tool is spaced away from the housing when connected to the tool holder, and the insertion tool substantially does not come into contact with the housing during operation of the hand-held power tool. The spacing component is configured as a spacer, for example. The spacing component may be annular, disc-shaped, or plate-shaped.

In one embodiment of the hand-held power tool, the spacing component is attachable to the tool holder. The spacing component may be attachable such that, when using the spacing component, the tool holder can be used in a substantially unhindered manner. The spacing component may be connectable to the tool holder in an interlocking or force-fitting manner, for example.

In one embodiment of the hand-held power tool, the spacing component comprises a receptacle for the tool holder. The receptacle for the tool holder may comprise an internal receptacle for the tool holder. The internal receptacle for the tool holder may comprise a corresponding shape for the tool holder. An arrangement of the spacing component on the tool holder by way of the internal receptacle of the spacing component allows for an optimal torque transfer from the tool holder to the insertion tool.

In one embodiment of the hand-held power tool, the tool holder has a transition section, wherein the receptacle of the spacing component is arrangeable on the transition section. The receptacle of the spacing component is configured such that the receptacle of the spacing component receives the transition section. The receptacle of the spacing component and the transition section are configured such that they correspond to each other. The internal receptacle of the spacing component is configured in a manner that corresponds to the transition section. The tool holder additionally comprises a torque transfer section and/or a drive section. The torque transfer section is configured to transfer torque to the insertion tool. The torque transfer section may be polygonal, such as quadrilateral. For example, the torque transfer section may be substantially cube-shaped. Furthermore, the tool holder may comprise an output section. The output section may terminate in the anvil cam. The output section may be cylindrical, for example. The output section is configured to transfer rotational movement received by the anvil cams to the transition section. The transition section may be located between the torque transfer section and the output section.

In one embodiment of the hand-held power tool, the transition section has a radius in the range of 3 mm to 8 mm. The radius is configured in an optimized way to increase stability and robustness of the transition section. Preferably, the radius is formed in a range between 5 mm and 7 mm.

In one embodiment of the hand-held power tool, the receptacle of the spacing component comprises a polygonal section. The polygonal section of the receptacle of the spacing component is polygonal in that it is shaped in a manner that corresponds to the torque transfer section. The polygonal section allows the spacing component to come into contact in at least a form-fitting manner with the tool holder, and particularly at least partially with the torque transfer section. For example, the polygonal section may be configured according to a cube, hollow cube, cuboid, or hollow cuboid. The polygonal section may be configured in the direction of the tool holder and/or the insertion tool.

In one embodiment of the hand-held power tool, the receptacle of the spacing component comprises a cylindrical section. The cylindrical section of the receptacle of the spacing component is configured to correspond to the output section. The cylindrical section allows the spacing component to come into contact with the tool holder in at least a form-fitting manner. The cylindrical section may be configured in the direction of the power unit.

In one embodiment of the hand-held power tool, the spacing component comprises a contact element configured to receive the insertion tool. For example, the contact element may be configured as a contact surface of the spacing component. The contact element may be located away from the power unit when the insertion tool is connected to the tool holder. The contact element may be connected to the spacing component. It is possible that the contact element and the spacing component may be of one piece. The spacing component and the contact element may be formed from an elastic material. Both the contact element and the spacing component may serve to dampen vibrations during operation of the hand-held power tool. The contact element may be configured in a disc-shaped or annular fashion, by way of example.

In one embodiment of the hand-held power tool, the spacing component can be positioned spaced apart from the housing and/or a percussion mechanism housing at the tool holder. The spacing component may be positioned spaced apart from the tool holder such that, when operating the hand-held power tool, in particular the tool holder, the spacing component does not come into contact with the housing and/or the percussion mechanism housing.

The disclosure also concerns the spacing component for the hand-held power tool described herein.

### BRIEF DESCRIPTION OF THE DRAWINGS

The disclosure is explained below with reference to preferred embodiments. The drawings show:

FIG. 1 a schematic view of a hand-held power tool according to the disclosure;

FIG. 2a a side view of the hand-held power tool with a spacing component;

FIG. 2b the side view of the hand-held power tool with the connected spacing component;

FIG. 3 a cutout of a longitudinal section of a tool holder of the hand-held power tool with the connected spacing component;

### DETAILED DESCRIPTION

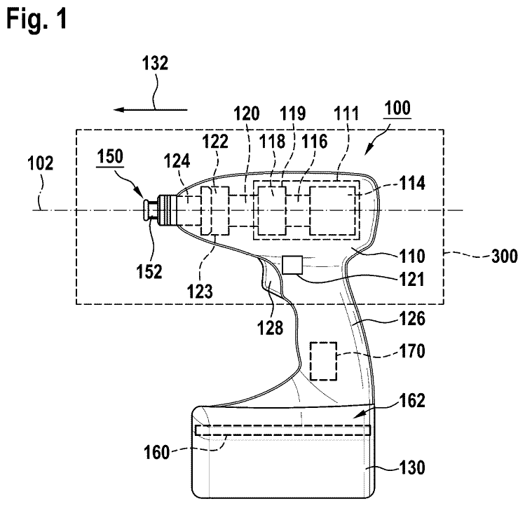

FIG. 1 shows a hand-held power tool 100 according to the disclosure, which is configured as a cordless rotary impact screwdriver 100, for example. The hand-held power tool 100 comprises a tool holder 150. The hand-held power tool 100 comprises a housing 110 with a handle 126. To provide a power supply that is independent of the electric grid, the hand-held power tool 100 can be mechanically and electrically connected to a power supply for cordless operation, so that the hand-held power tool 100 is configured as a cordless hand-held power tool 100. A hand-held power tool rechargeable battery pack 130 is used here as the power supply. The present disclosure is not limited to cordless hand-held power tools, however, but can also be used for those dependent on the electric grid, i.e. plug-in hand-held power tools.

The housing 110 comprises a drive unit 111. The drive unit 111 is located in the housing 110. The drive unit 111 comprises an electrically commutated drive motor 114, which is supplied with power by the hand-held power tool rechargeable battery pack 130, and a transmission 118. The transmission 118 is designed as at least one planetary gear. The drive motor 114 is designed such that it can be actuated, for example via a manual switch 128, so that the drive motor 114 can be switched on and off. The drive motor 114 can advantageously be electronically controlled and/or regulated, so that a reversing mode and a desired rotational speed can be implemented. For the reversing mode, the hand-held power tool 100 comprises a rotation direction switching element 121 configured as a rotation direction changeover switch. The rotation direction switching element 121 is configured to switch the drive motor 114 between a clockwise direction of rotation and a counterclockwise direction of rotation. The design and mode of operation of a suitable drive motor are sufficiently well-known to those skilled in the art, which is why they will not be discussed in more detail here.

The housing 110 at least partially accommodates the drive motor 114, the transmission 118 and the tool holder 150. The housing 110 is formed here as a shell housing with two half shells 112.

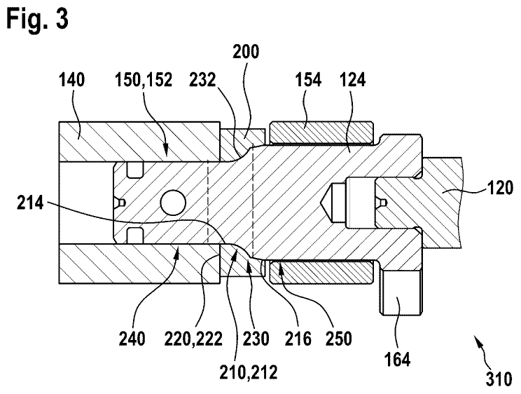

The hand-held power tool 100 configured as a cordless rotary impact screwdriver comprises a percussion mechanism 122, particularly a rotary percussion mechanism 122, with an intermediate shaft 120. Both the rotary percussion mechanism 122 and the intermediate shaft 120 are located within the housing 110. The rotary percussion mechanism 122 comprises a percussion mechanism housing 123, wherein the rotary percussion mechanism 122 can also be located in another suitable housing, such as the transmission housing 119. The rotary percussion mechanism 122 comprises a striker and a percussion mechanism spring. The striker and the percussion mechanism spring are not shown in further detail. The striker and the percussion mechanism spring are located substantially within the percussion mechanism housing 123. The striker has two striking cams not shown in more detail. The rotary percussion mechanism 122 is configured to drive an output shaft 124. The hand-held power tool 100 comprises a tool axis 102, wherein an axis of rotation of the drive shaft 124 forms the tool axis 102. The output shaft 124 is configured to drive the tool holder 150. The tool holder 150 is provided on the output shaft 124. The tool holder 150 is preferably molded onto and/or designed on the output shaft 124. The tool holder 150 is preferably located in an axial direction 132 with respect to the drive unit 111. The tool holder 150 or the output shaft 124, respectively, include two anvil cams 164 at one end in the direction of the rotating percussion mechanism 122 and/or the power unit 111, see also FIG. 3. The striker of the rotary percussion mechanism 122 is provided to rotate the anvil cams in the circumferential direction by way of the striking cams and thereby drive the tool holder 150 and the output shaft 124, respectively. The tool holder 150 is formed as an external tool holder 152, such as a nut holder. The tool holder 150 is configured to receive insertion tools 140, such as socket wrenches or sockets.

The hand-held power tool 100 comprises a control unit 170 at least for controlling the drive unit 111, in particular the drive motor 114. The housing 110 at least partly accommodates the control unit 170.

The housing 110 also comprises a power supply holding device 160. The power supply holding device 160 accommodates the hand-held power tool rechargeable battery pack 130 and forms a base 162 comprising a standing surface. The hand-held power tool rechargeable battery pack 130 can be released from the power supply holding device 160 without tools. The housing 110 also comprises the handle 126 and the power supply holding device 160. The handle 126 can be grasped by the user. In one embodiment, the power supply holding device 160 is located on the handle 126. The hand-held power tool 100 can be set down on the base 162.

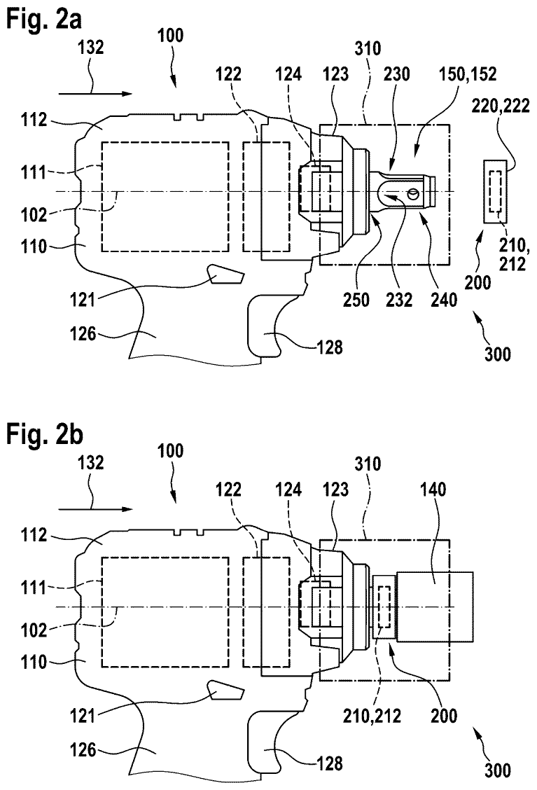

FIG. 2 shows a side view 300 of the hand-held power tool 100. FIG. 2a shows the side view 300 with a spacing component 200. FIG. 2b shows the side view 300 of the hand-held power tool 100 with the spacing component 200 connected. The hand-held power tool 100 comprises the spacing component 200. The spacing component is provided to space the insertion tool 140 away from the housing. The spacing component 200 spaces the insertion tool 140 such that the insertion tool 140 is spaced away from the housing 110 when connected to the tool holder 150, and the insertion tool at least substantially does not come into contact with the housing during operation of the hand-held power tool 100. The spacing component 200 is configured, for example, as an annular spacer. The spacing component 200 is attachable to the tool holder 150. The spacing component 200 is connectable at least in a form-fitting manner to the tool holder 150. The spacing component 200 comprises a receptacle 210 for the tool holder 150, wherein the receptacle 210 is configured as an internal receptacle 212 for the tool holder 150. The internal receptacle 212 for the tool holder 150 comprises a corresponding shape to the tool holder 150.

The tool holder 150 comprises a transition section 230. The receptacle 210 of the spacing component 200 is arrangeable on the transition section 230, wherein the receptacle 210 of the spacing component 200 is shaped such that the receptacle 210 of the spacing component 200 receives the transition section 230. Furthermore, the receptacle 210 of the spacing component 200 and the transition section 230 are configured such that they correspond to each other. The tool holder 150 comprises a torque transfer section 240 and/or a drive section. The torque transfer section 240 is provided to transfer torque to the insertion tool 150. Here, the torque transfer section is polygonal, such as quadrilateral, and is substantially cube-shaped. The tool holder 150 comprises an output section 250. The output section 250 terminates in the anvil cam 164, see also FIG. 3. The output section 250 is shaped cylindrically here as an example. The transition section 230 is located between the torque transfer section 240 and the output section 250. The transition section 240 has a radius 232 in the range of 3 mm to 8 mm.

The spacing component 200 includes a contact element 220. The contact element 220 is provided to receive the insertion tool 150 such that the insertion tool 150 comes into contact with the contact element 220 during operation of the hand-held power tool 100. By way of example, the contact element 220 is designed as a contact surface 222. The contact element 220 is located away from the power unit 111 when the insertion tool 140 is connected to the tool holder 150. The spacing component 200 here forms the contact element 220 so that these are of one piece. The spacing component 200 and the contact element 220 are made of an elastic material. For example, the contact element 220 is shaped like a disc. The spacing component 200 is spaced apart from the housing 110 and/or the percussion mechanism housing 123 at the tool holder 150.

FIG. 3 shows a cutout 310 of a longitudinal section of a tool holder of the hand-held power tool 100 with the connected spacing component 200. The receptacle 210 of the spacing component 200 comprises a polygonal section 214. The polygonal section 214 of the receptacle 210 of the spacing component 200 is polygonal in that it is shaped in a manner that corresponds to the torque transfer section 240. The polygonal section 214, in the connected state, may at least partially come into contact with the torque transfer section 240 in a form-fitting manner. By way of example, the polygonal section 214 is shaped in the manner of a hollow cube and is shaped in the direction of the tool holder 150 or the insertion tool 140. The receptacle 210 of the spacing component 200 comprises a cylindrical section 216. The cylindrical section 216 of the receptacle 210 of the spacing component 200 is shaped to correspond to the output section 250. The cylindrical section 214 thus allows the spacing component 200 to come into contact with the output section 250 of the tool holder 150 in at least a form-fitting manner. The cylindrical section 216 is shaped in the direction of the power unit 111.

What is claimed is:

1. A hand-held power tool, comprising:
a housing with a power unit;
a percussion mechanism configured to be driven by the power unit;
a tool holder configured to receive an insertion tool, wherein the tool holder is further configured to be driven by the percussion mechanism, at least partially; and
a spacing component configured to space the insertion tool away from the housing.

2. The hand-held power tool according to claim 1, wherein the spacing component is further configured to be attached to the tool holder.

3. The hand-held power tool according to claim 1, wherein the spacing component has a receptacle configured to receive the tool holder.

4. The hand-held power tool according to claim 3, wherein:
the tool holder comprises a transition section, and
the receptacle is configured to be arranged on the transition section.

5. The hand-held power tool according to claim 4, wherein the transition section has a radius in the range of 3 mm to 8 mm.

6. The hand-held power tool according to claim 3, wherein the receptacle comprises a polygonal section.

7. The hand-held power tool according to claim 3, wherein the receptacle comprises a cylindrical section.

8. The hand-held power tool according to claim 1, wherein the spacing component comprises a contact element configured to receive the insertion tool.

9. The hand-held power tool according to claim 1, wherein the spacing component is arranged so as to be spaced apart from the housing and/or a percussion mechanism housing at the tool holder.

10. A spacer for the hand-held power tool according to claim 1.

11. The hand-held power tool according to claim 1, wherein the power unit is located within the housing.
